(19) United States
(12) Patent Application Publication
(10) Pub. No.: US 2025/0079472 A1
(43) Pub. Date: Mar. 6, 2025

(54) SOLID OXIDE CELL AND MANUFACTURING METHOD THEREOF

(71) Applicant: SAMSUNG ELECTRO-MECHANICS CO., LTD., Suwon-si, Gyeonggi-do, (KR)

(72) Inventors: Byungchul Jang, Suwon-si, Gyeonggi-do (KR); Jeongsuong Yang, Suwon-si, Gyeonggi-do (KR); Dongjin Kim, Suwon-si, Gyeonggi-do (KR); Areum Jun, Suwon-si, Gyeonggi-do (KR); Jaeseok Yi, Suwon-si, Gyeonggi-do (KR); Hyegsoon An, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/285,458

(22) PCT Filed: Sep. 6, 2023
(86) PCT No.: PCT/KR2023/013321

§ 371 Date: Oct. 3, 2023

(30) Foreign Application Priority Data
Nov. 24, 2022 (KR) 10-2022-0159245
Apr. 5, 2023 (KR) 10-2023-0044925

(51) Int. Cl. H01M 4/86; C25B 9/23; C25B 11/031; C25B 11/037; C25B 11/047; C25B 13/07; H01M 4/90; H01M 8/12; H01M 8/1213; H01M 8/1253; H01M 8/126

(52) U.S. Cl. CPC H01M 4/8626; C25B 9/23; C25B 11/031; C25B 11/037; C25B 11/047; C25B 13/07; H01M 4/8621; H01M 4/9033; H01M 8/1213; H01M 8/1253; H01M 8/126; H01M 2004/8684; H01M 2008/1293; H01M 2300/0077

(57) ABSTRACT

A solid oxide cell including a solid oxide electrolyte, and a fuel electrode on one side of the solid oxide electrolyte and an air electrode on the other side, wherein the fuel electrode includes core-shell hollow particles in which the core has an empty space and the shell includes nickel oxide (NiO) particles.

### TECHNICAL FIELD

This application claims priority to and the benefit of Korean Patent Application No. 10-2022-0159245 filed in the Korean Intellectual Property Office on Nov. 24, 2022, and Korean Patent Application No. 10-2023-0044925 filed in the Korean Intellectual Property Office on Apr. 5, 2023, the entire contents of which is incorporated herein by reference.

This disclosure relates to solid oxide cell and a manufacturing method thereof.

### BACKGROUND ART

A solid oxide fuel cell (SOFC) and a solid oxide electrolyzer cell (SOEC) generate electrical energy through an electrochemical reaction of a cell composed of an air electrode, a fuel electrode a solid oxide electrolyte having oxygen ion conductivity or electrolyze water and generate hydrogen through a reverse reaction of the solid oxide fuel cell. The cell has a configuration in which the air electrode and the fuel electrode are respectively disposed at both sides of the solid oxide electrolyte having oxygen ion conductivity, wherein air and hydrogen am respectively supplied to the air electrode and the fuel electrode through gas flow paths formed on a separator to have the electrochemical reaction to generate electricity or perform electrolysis.

In particular, the solid oxide electrolyzer cell operates at 800° C. or higher and thus requires material properties which are stable in an oxidation/reduction reaction at a high temperature. In addition, the fuel electrode needs to have a pore structure through which water may well diffuse and move.

### DISCLOSURE OF INVENTION

### Technical Problem

One aspect of the present disclosure provides a solid oxide cell that forms a fuel electrode having a porous structure without a pore former, thereby securing a three-phase interface in which water can be smoothly decomposed by an electrochemical reaction, maintaining a structure during firing, and performing stable oxidation-reduction reactions at a high temperature.

### Solution to Problem

A solid oxide cell according to one aspect includes a solid oxide electrolyte, a fuel electrode on one side of the solid oxide electrolyte, the fuel electrode including hollow particles including a core having an empty space, and a shell including nickel oxide (NiO) particles, and an air electrode on the other side of the solid oxide electrolyte.

The hollow particles may have a sphere shape.

The hollow particles may have an average particle diameter of 1 μm to 10 μm.

The fuel electrode may further include a solid oxide electrolyte material.

The solid oxide electrolyte material may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The solid oxide electrolyte material may be in a form of particles having an average particle diameter of 3 μm to 20 μm.

The fuel electrode may include 30 parts by weight to 70 parts by weight of the hollow particles based on 100 parts by weight of the solid oxide electrolyte material.

The fuel electrode may further include a fuel electrode material including nickel (Ni), nickel oxide, cobalt (Co), cobalt oxide, ruthenium (Ru), ruthenium oxide, palladium (Pd), palladium oxide, platinum (Pt), platinum oxide, or a combination thereof.

The fuel electrode material may be in a form of particles having an average particle diameter of 0.1 μm to 5 μm.

The fuel electrode may include 30 parts by weight to 70 parts by weight of the fuel electrode material based on 100 parts by weight of the solid oxide electrolyte material.

The solid oxide electrolyte may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The air electrode may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

The air electrode may further include a solid oxide electrolyte material.

The solid oxide cell may be a solid oxide fuel cell (SOFC), a solid oxide electrolyzer cell (SOEC), or both.

A method of manufacturing a solid oxide cell according to another aspect of the disclosure includes forming a fuel electrode from a composition including hollow particles including core having an empty space and a shell including nickel oxide (NiO) particles.

The composition may further include a solid oxide electrolyte material.

The composition may further include a fuel electrode material.

The composition for forming the fuel electrode may include 30 parts by weight to 70 parts by weight of hollow particles based on 100 parts by weight of the solid oxide electrolyte material.

The composition for forming the fuel electrode may include 30 parts by weight to 70 parts by weight of the fuel electrode material based on 100 parts by weight of the solid oxide electrolyte material.

The forming of the fuel electrode may include casting the composition and then firing the casted composition.

A solid oxide cell according to one aspect includes a solid oxide electrolyte, a fuel electrode on one side of the solid oxide electrolyte, the fuel electrode including a fuel electrode material, and hollow particles that include a core having an empty space, and a shell including nickel oxide (NiO) particles, and an air electrode on the other side of the solid oxide electrolyte.

The fuel electrode may further include a solid oxide electrolyte material.

The fuel electrode may include 30 parts by weight to 70 parts by weight of the hollow particles based on 100 parts by weight of the solid oxide electrolyte material.

The fuel electrode material may include nickel (Ni), nickel oxide, cobalt (Co), cobalt oxide, ruthenium (Ru), ruthenium oxide, palladium (Pd), palladium oxide, platinum (Pt), platinum oxide, or a combination thereof.

The fuel electrode may include 30 parts by weight to 70 parts by weight of the fuel electrode material based on 100 parts by weight of the solid oxide electrolyte material.

The shell may be free of other metal oxides.

### Advantageous Effects of Invention

According to the solid oxide cell according to one aspect, it is possible to secure a three-phase interface in which water can be smoothly decomposed by an electrochemical reaction by forming a porous fuel electrode without a pore former, to maintain the structure during firing and to perform stable oxidation-reduction reactions at a high temperature.

### BRIEF DESCRIPTION OF DRAWINGS

FIG. 1 is a schematic view schematically illustrating a cross-section of a solid oxide cell according to one aspect.

FIG. 2 is a scanning electron microscope (SEM) photograph of hollow particles.

FIG. 3 is a transmission electron microscope (TEM) photograph of hollow particles.

FIG. 4 is a schematic view illustrating a solid oxide fuel cell according to a modified embodiment of one aspect.

FIG. 5 is a schematic view illustrating a solid oxide water electrolysis cell according to another modified embodiment of one aspect.

### MODE FOR THE INVENTION

Hereinafter, with reference to the accompanying drawings, the present disclosure will be described in detail so as to facilitate practice by one having ordinary skill in the art to which it belongs. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present disclosure includes all modifications, equivalents, and substitutions without departing from the scope and spirit of the present disclosure. In addition, some components are exaggerated, omitted, or schematically depicted in the accompanying drawings, and the dimensions of each component are not necessarily indicative of actual dimensions.

In addition, unless explicitly described to the contrary, the word “comprise”, and variations such as “comprises” or “comprising”, will be understood to imply the inclusion of stated elements but not the exclusion of any other elements.

As disclosed herein, the average particle diameter may be obtained using a particle size analyzer. Other methods and/or tools appreciated by one of ordinary skill in the art, even if not described in the present disclosure, may also be used.

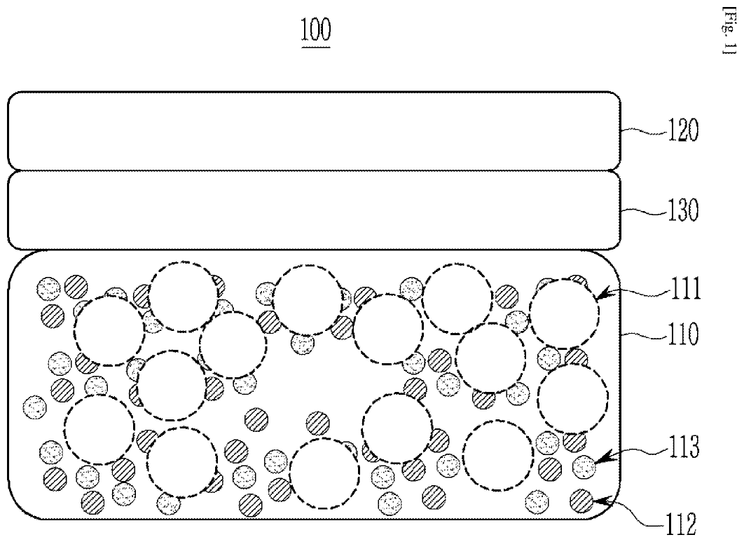

FIG. 1 is a schematic view schematically illustrating a cross-section of a solid oxide cell according to one aspect.

Referring to FIG. 1, the solid oxide cell 100 includes a solid oxide electrolyte 130, a fuel electrode 110 disposed on one side of the solid oxide electrolyte 130, and an air electrode 120 disposed on the other side.

The fuel electrode 110 serves to electrochemically oxidize fuel and transfer charges. Therefore, the fuel electrode 110 needs a pore structure that allows the diffusion of fuel to proceed smoothly.

In the case that, in order to secure pores in the fuel electrode 110, a pore former such as a spherical polymer or a carbon material is mixed, molded and printed, and then heat treated to form a pore structure by decomposing the pore former, it is not easy to control pores due to uniform dispersion of the pore former and its change over time when preparing a slurry or paste for molding and printing, and there is a possibility that the porous structure will collapse when the pore formers are decomposed by heat treatment.

In the solid oxide cell 100 according to one aspect, the fuel electrode 110 includes core-shell hollow particles 111 in which a core has an empty space and a shell includes nickel oxide (NiO) particles. For example, the hollow particles 111 are secondary particles formed by aggregation of nickel oxide particles, which are primary particles, and may include an empty space therein. That is, the hollow particles 111 may have a core-shell shape in which a core has an empty space and a shell includes nickel oxide particles.

In other words, the fuel electrode 110 includes nickel oxide particles having a hollow core structure and may have a porous structure without a pore former, thereby securing a three-phase interface on which a fuel may be smoothly decomposed by an electrochemical reaction. In addition, a nickel oxide, which is a stable material at a high temperature, maintains the porous structure during the firing and is stable in an oxidation/reduction reaction at a high temperature.

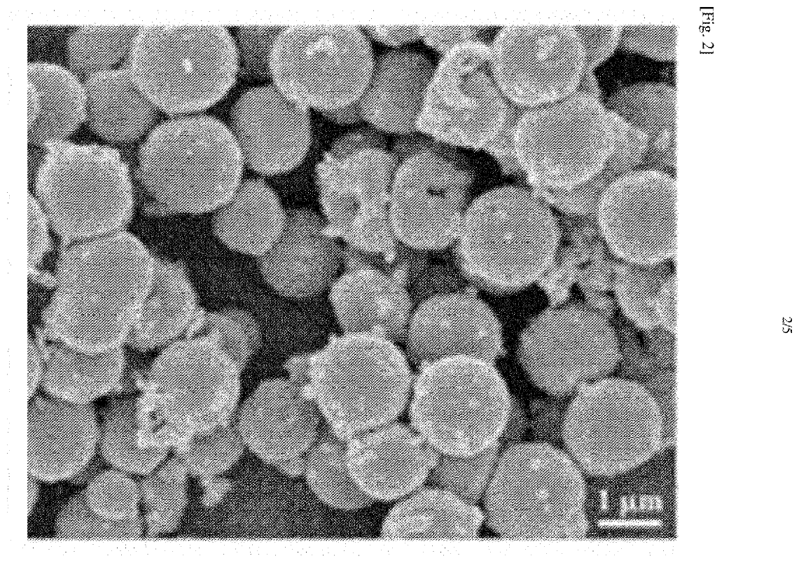

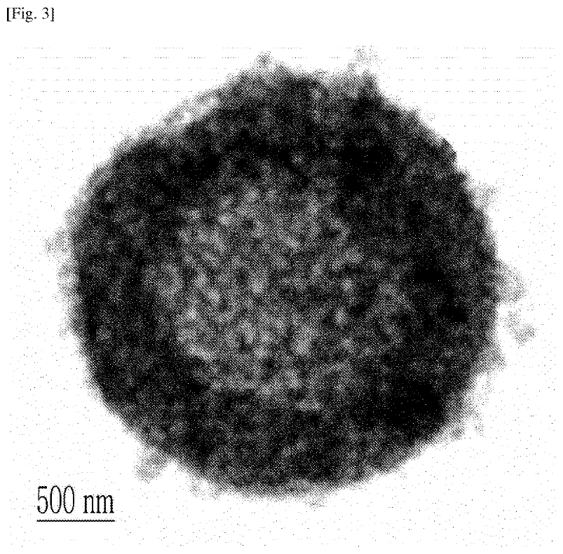

FIG. 2 is a scanning electron microscope (SEM) photograph of hollow particles 111, and FIG. 3 is a transmission electron microscope (TEM) photograph of hollow particles 111.

Referring to FIGS. 2 and 3, the hollow particles 111 may have a substantially sphere shape. However, the solid oxide cell 100 according to the present aspect is not limited thereto, but the hollow particles 111 may have, for example, a sphere shape having an overall cross-section, a polyhedron shape, etc.

The hollow particles 111 may have an average particle diameter of 1 μm to 10 μm. When the hollow particles 111 have an average particle diameter of less than 1 μm, pores are too small to secure a smooth pore structure, but when the average particle diameter is greater than 10 μm, mechanical strength may be weakened due to excessive pores.

The fuel electrode 110 may further include a solid oxide electrolyte material 113.

The solid oxide electrolyte material 113 should have high oxygen ion conductivity and low electronic conductivity.

For example, the solid oxide electrolyte material 113 may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The solid oxide electrolyte material 113 may be in the form of particles having an average particle diameter of 3 μm to 20 μm. When the solid oxide electrolyte material 113 has an average particle diameter of less than 3 μm, ion conductivity may be deteriorated due to a small grain size after the sintering, but when greater than 20 μm, sinterability may decrease, deteriorating density.

When the fuel electrode 110 may include 30 parts by weight to 70 parts by weight of the hollow particles 111 based on 100 parts by weight of the solid oxide electrolyte material 113. When the hollow particles 111 are included in an amount of less than 30 parts by weight, the content of the fuel electrode material is insufficient, deteriorating electrical characteristics, but when greater than 70 parts by weight, the content of the solid oxide electrolyte material is insufficient, deteriorating ion conductivity.

The fuel electrode 110 may further include a fuel electrode material 112. The fuel electrode material 112 may electrochemically oxidize a fuel and transfer electric charges.

For example, the fuel electrode material 112 may include pure metals such as nickel (Ni), cobalt (Co), ruthenium (Ru), palladium (Pd), or platinum (Pt), and the like, or oxides thereof.

Herein, the fuel electrode 110 may include a cermet which is a composite of the fuel electrode material 112 and the solid oxide electrolyte material 113. For example, when the solid oxide electrolyte material 113 is yttria-stabilizing zirconia (YSZ), while the fuel electrode material 112 is nickel (Ni), the porous solid oxide composite may be Ni/YSZ cermet, and when the fuel electrode material 112 is ruthenium (Ru), the porous solid oxide composite may be Ru/YSZ cermet.

The fuel electrode material 112 may have an average particle diameter of 0.1 μm to 5 μm or 0.5 μm to 5 μm. When the fuel electrode material 112 has an average particle diameter of less than 0.1 μm, it is difficult to connect the fuel electrode materials themselves, deteriorating electronic conductivity, and when greater than 5 μm, an active specific surface area is reduced, deteriorating electrical characteristics.

The fuel electrode 110 may include 30 parts by weight to 70 parts by weight of the fuel electrode material 112 based on 100 parts by weight of the solid oxide electrolyte material 113. When the fuel electrode material 112 is included in an amount of less than 30 parts by weight, ion conductivity may be deteriorated, and when greater than 70 parts by weight, electronic conductivity may be deteriorated.

For example, the fuel electrode 110 may, for example, have a thickness of 1 μm to 1000 μm or 5 μm to 100 μm.

The fuel electrode 110 may have porosity of 20% to 60%. When the fuel electrode 110 has porosity of less than 20%, mass flow resistance of raw materials and produced gas may be increased, and when greater than 60%, mechanical strength may be deteriorated.

The air electrode 120 includes an air electrode material. The air electrode material may be a material that reduces oxygen gas into oxygen ions.

For example, the air electrode material may include metal oxide particles having a perovskite-type crystal structure. The perovskite-type metal oxide is a mixed ionic and electronic conductor (MIEC) material having both ionic and electronic conductivity, and has a high oxygen diffusion coefficient and a charge exchange reaction rate coefficient, allowing an oxygen reduction reaction to occur on the entire surface of the electrode, not just at the three-phase interface.

The perovskite-type metal oxide may be represented by Chemical Formula 1.

ABO_{3±γ} [Chemical Formula 1]

In Chemical Formula 1, A is an element including La, Ba, Sr, Sm, Gd, Ca, or a combination thereof, B is an element including Mn, Fe, Co, Ni, Cu, Ti, Nb, Cr, Sc, or a combination thereof, and γ indicates an oxygen excess or deficiency. The γ may be for example, in the range of 0≤γ≤0.3.

For example, the perovskite-type metal oxide may be represented by Chemical Formula 2.

A′₁₋ₓA″ₓB′O_{3±γ} [Chemical Formula 2]

In Chemical Formula 2, A′ is an element including Ba, La, Sm, or a combination thereof, A″ is an element including Sr, Ca, Ba, or a combination thereof and is different A′, B′ is an element including Mn, Fe, Co, Ni, Cu, Ti, Nb, Cr, Sc, or a combination thereof, 0≤x<1, and γ indicates an oxygen excess or deficiency.

For example, the air electrode material may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

In this case, if the solid oxide electrolyte material is an yttria-stabilized zirconia (YSZ) and the air electrode material may be a lanthanum-strontium manganese oxide (LSM), the porous solid oxide composite may be an LSM-YSZ composite.

A thickness of the air electrode 120 may be, for example, 1 μm to 100 μm, or 5 μm to 50 μm.

The solid oxide electrolyte 130 plays a role of transporting the oxygen ions produced from the air electrode 120 to the fuel electrode 110 through ion conduction. The solid oxide electrolyte 130 has gas impermeability to block a contact between air and the fuel electrode 110 and also block the electrons produced at the fuel electrode 110 from directly moving toward the air electrode 120 due to high oxygen ion conductivity and low electronic conductivity (high electrical resistance, high insulation).

In addition, since the solid oxide electrolyte 130 has the air electrode 120 and the fuel electrode 110, which have a very large oxygen partial pressure, on both sides thereof, the aforementioned properties may be necessary to maintain in a wide oxygen partial pressure region.

A material constituting the solid oxide electrolyte 130 is not particularly limited as long as it is generally usable in the art, and examples thereof may an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

A thickness of the solid oxide electrolyte 130 may be, for example, 10 nm to 100 μm, or 100 nm to 50 μm.

Optionally, the solid oxide cell 100 may further include an electrical collecting layer (not shown) including an electrical conductor on at least one side of the air electrodes 120, for example an outer side of the air electrodes 120. The electrical collecting layer may act as a current collector to collect electricity in a configuration of the air electrode 120.

The electrical collecting layer may include, for example, a lanthanum cobalt oxide (LaCoO₃), a lanthanum strontium cobalt oxide (LSC), a lanthanum strontium cobalt iron oxide (LSCF), a lanthanum strontium cobalt manganese oxide (LSCM), a lanthanum strontium manganese oxide (LSM), a lanthanum strontium iron oxide (LSF), or a combination thereof. The electrical collecting layer may use the above-listed materials alone or in a combination of two or more, wherein these materials may be formed into a single layer or two or more layers with a stacked structure.

The solid oxide cell 100 may be applied to various structures such as a cylindrical (tubular) stack, a flat tubular stack, a planar type stack, and the like.

In addition, the solid oxide cell 100 may be in the form of a stack of unit cells. For example, the unit cells (Membrane and Electrode Assembly (MEA)) composed of the air electrode 120 and 310, the fuel electrode 110, and the solid oxide electrolyte 130 are stacked in series, and separators electrically connected between the unit cells are disposed, obtaining the stack of the unit cells.

For example, the solid oxide cell 100 may be a solid oxide fuel cell (SOFC), a solid oxide electrolyzer cell (SOEC), or both.

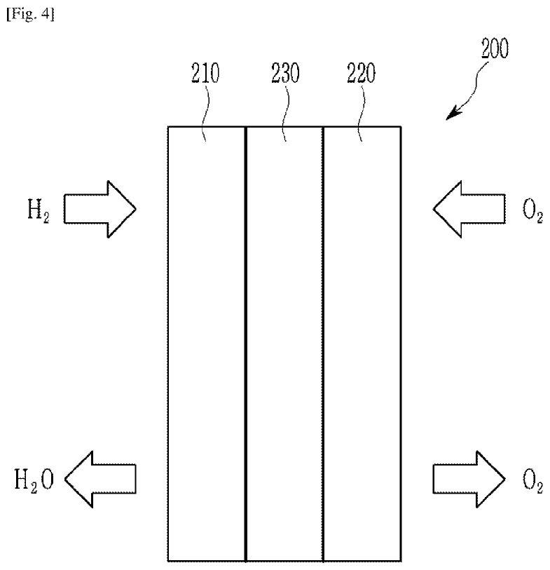

FIG. 4 is a schematic view showing a case that the solid oxide cell 100 is a solid oxide fuel cell.

Referring to FIG. 4, the solid oxide fuel cell 200 includes a fuel electrode 210, an air electrode 220 disposed facing the fuel electrode 110, and an oxygen ion conductive solid oxide electrolyte 230 disposed between the fuel electrode 210 and the air electrode 220.

The solid oxide fuel cell 200 has an electrochemical reaction as shown in Reaction Scheme 1, which exhibits an air electrode reaction in which oxygen gas (O₂) of the air electrode 220 is changed into oxygen ions (O₂⁻) and a fuel electrode reaction in which a fuel (H₂ or hydrocarbon) of the fuel electrode 210 reacts with the oxygen ions moved through and the electrolyte.

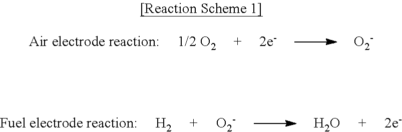

In the air electrode 220 of the solid oxide fuel cell 200, the oxygen adsorbed into the electrode surface is dissociated and moves through surface diffusion to the three-phase interface (triple phase boundary) where the solid oxide electrolyte 230, the air electrode 220, and pores (not shown) meet to gain electrons into oxygen ions, and the produced oxygen ions move toward the fuel electrode 210 through the solid oxide electrolyte 230.

In the fuel electrode 210 of the solid oxide fuel cell 200, the moved oxygen ions are combined with hydrogen in the fuel to produce water. At this time, the hydrogen emits the electrons to be hydrogen ions (H⁺) which combine with the oxygen ions. The discharged electrons move toward the air electrode 220 through a wire (not shown) to change the oxygen into the oxygen ions. Through this electron movement, the solid oxide fuel cell 200 may perform a battery function.

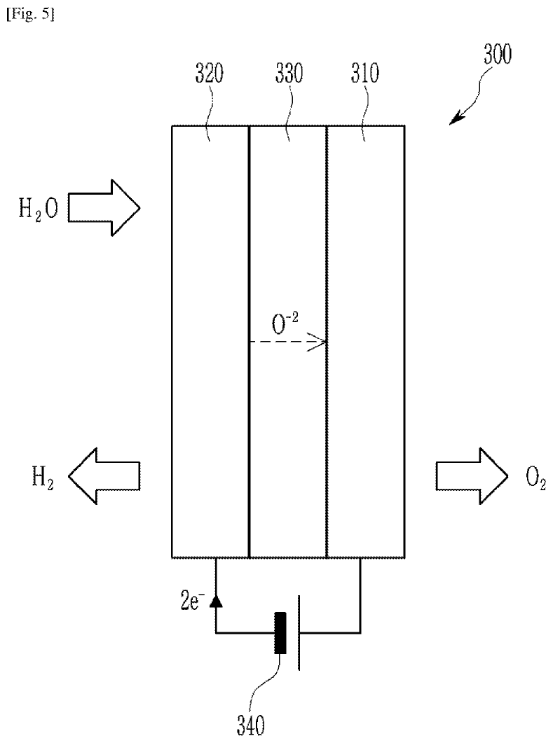

FIG. 5 is a schematic view illustrating a case where the solid oxide cell 100 is a solid oxide electrolyzer cell.

Referring to FIG. 5, a solid oxide electrolyzer cell 300 includes an air electrode 310, a fuel electrode 320 disposed facing the air electrode 310, and an oxygen ion conductive solid oxide electrolyte 330 disposed between the air electrode 310 and the fuel electrode 320.

The solid oxide electrolyzer cell 300 has an electrochemical reaction shown in Reaction Scheme 2, which exhibits a fuel electrode reaction where water (H₂O) of the fuel electrode 320 is changed into hydrogen gas (H₂) and oxygen ions (O₂⁻) and an air electrode reaction wherein the oxygen ions moved through the solid oxide electrolyte 330 are changed into oxygen gas (O₂). This reaction is contrary to reaction principles of a conventional fuel cell.

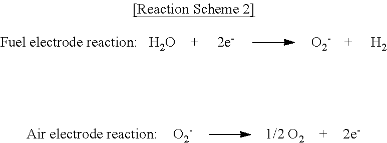

When electric power is applied to the solid oxide electrolyzer cell 300 from an external power source 340, the solid oxide electrolyzer cell 300 is supplied with electrons from the external power source 340. The electrons react with water supplied to the fuel electrode 320 to generate the hydrogen gas and the oxygen ions. The hydrogen gas is discharged to the outside, and the oxygen ions pass through the electrolyte 330 to the air electrode 310. The oxygen ions moved to the air electrode 310 lose electrons and then, are changed into oxygen gas and discharged to the outside. The electrons flow to the external power source 340. Through this electron movement, the solid oxide electrolyzer cell 300 may electrolyze the water to form the hydrogen gas at the fuel electrode 320 and form the oxygen gas at the air electrode 310.

A method of manufacturing a solid oxide cell according to another aspect includes forming a fuel electrode, forming a solid oxide electrolyte on the fuel electrode, and forming an air electrode on the solid oxide electrolyte.

The fuel electrode may be manufactured by casting a composition for forming a fuel electrode into, for example, a sheet shape, and then firing the resultant.

The composition for forming a fuel electrode includes core-shell hollow particles in which the core has an empty space and the shell includes nickel oxide (NiO) particles, and optionally further includes a solid oxide electrolyte material, a fuel electrode material, or a combination thereof. Since descriptions of the hollow particles, the solid oxide electrolyte material, and the fuel electrode material are the same as those described above, repetitive descriptions will be omitted.

However, the hollow particles may be manufactured through templated synthesis. A template may be manufactured by spherical shape particles such as a polymer, silica (SiO₂), or carbon, etc.

In addition, the composition for forming a fuel electrode optionally may further include a dispersant, a plasticizer, a binder, a solvent, or the like and may be in the form of slurry, paste, or dispersion.

The composition for forming a fuel electrode may be cast into a sheet shape in a wet method, for example, a dipping method, a coating method, a printing method, a spray method, or the like.

The composition for forming a fuel electrode may include 30 parts by weight to 70 parts by weight of the hollow particles based on 100 parts by weight of the solid oxide electrolyte material. When the hollow particles are included in an amount of less than 30 parts by weight, the content of the fuel electrode material is insufficient, deteriorating electrical characteristics, and greater than 70 parts by weight, the content of the solid oxide electrolyte material is insufficient, deteriorating ion conductivity.

The composition for forming a fuel electrode may include 30 parts by weight to 70 parts by weight of the fuel electrode material based on 100 parts by weight of the solid oxide electrolyte material. When the content of the fuel electrode material is included in an amount of less than 30 parts by weight, the ion conductivity may be deteriorated, and when greater than 70 parts by weight, the electronic conductivity may be deteriorated.

For example, the firing may be performed at 1000° C. to 1500° C., for example 1300° C. to 1500° C., or 1400° C. to 1450° C. under an air atmosphere. However, the method of manufacturing a solid oxide cell according to the present aspect is not limited thereto, but the firing of the fuel electrode may be performed with the solid oxide electrolyte after forming the solid oxide electrolyte.

The solid oxide electrolyte may be formed, for example, by casting a composition for a solid oxide electrolyte into a sheet shape on the fuel electrode and then, firing it.

The composition for a solid oxide electrolyte may include a solid oxide electrolyte material. Description of the solid oxide electrolyte material may be the same as described above and will not be repeated. In addition, the composition for a solid oxide electrolyte may optionally include a dispersant, a plasticizer, a binder, a solvent, or the like and be in the form of slurry, paste, or dispersion.

The composition for a solid oxide electrolyte may be cast into a sheet shape in a wet method, for example, a dipping method, a coating method, a printing method, or a spray method, etc. For example, the composition for a solid oxide electrolyte may be cast on the fuel electrode.

For example, the firing may be performed at 1000° C. to 1500° C., for example, 1300° C. to 1500° C. or 1400° C. to 1450° C., under an air atmosphere.

The air electrode may be formed by casting a composition for an air electrode, for example, into a sheet shape and then, firing it.

The composition for an air electrode may include an air electrode material and a solid oxide electrolyte material. Description of the air electrode material and the solid oxide electrolyte material are the same as above and will not be repeated. In addition, the composition for an air electrode may further include optionally a dispersant, a plasticizer, a binder, or a solvent, etc. and be in the form of slurry, paste, or dispersion.

The composition for an air electrode may be cast into a sheet shape in a wet method, for example, a dipping method, a coating method, a printing method, or a spray method, or the like and be into the sheet shape on the solid oxide electrolyte.

For example, the firing may be 1000° C. to 1500° C., for example 1300° C. to 1500° C. or 1400° C. to 1450° C. under an air atmosphere.

In the above, the formation of the solid oxide electrolyte on the fuel electrode and sequentially, the air electrode on the solid oxide electrolyte is described, but the method of manufacturing a solid oxide cell according to the present aspect is not limited thereto, but the fuel electrode, the air electrode, and the solid oxide electrolyte may be respectively manufactured and then, stacked, or after forming the solid oxide electrolyte on the air electrode, the fuel electrode may be sequentially formed on the solid oxide electrolyte.

In addition, it is described that the firing is respectively performed after forming the fuel electrode, after forming the solid oxide electrolyte, and after forming the air electrode, but the method of manufacturing a solid oxide cell according to the present aspect is not limited thereto, and after forming the solid oxide electrolyte on the fuel electrode, the air electrode may be formed on the solid oxide electrolyte and then, fired all at once, or the solid oxide electrolyte may be formed on the fuel electrode and then, fired, and the air electrode may be formed thereon and then, fired.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

### INDUSTRIAL APPLICABILITY

This disclosure relates to a solid oxide cell and a method of manufacturing the same, and the solid oxide cell forms a fuel electrode having a porous structure without a pore former, thereby securing a three-phase interface in which water can be smoothly decomposed by an electrochemical reaction, maintaining a structure during firing, and performing stable oxidation-reduction reactions at a high temperature.

1. A solid oxide cell, comprising
a solid oxide electrolyte,
a fuel electrode on one side of the solid oxide electrolyte, the fuel electrode including hollow particles including:
a core having an empty space, and
a shell including nickel oxide (NiO) particles, and
an air electrode on the other side of the solid oxide electrolyte.

2. The solid oxide cell of claim 1, wherein
the hollow particles have a sphere shape.

3. The solid oxide cell of claim 1, wherein
the hollow particles have an average particle diameter of 1 μm to 10 μm.

4. The solid oxide cell of claim 1, wherein
the fuel electrode further includes a solid oxide electrolyte material.

5. The solid oxide cell of claim 4, wherein
the solid oxide electrolyte material includes an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

6. The solid oxide cell of claim 4, wherein
the solid oxide electrolyte material is in a form of particles having an average particle diameter of 3 μm to 20 μm.

7. The solid oxide cell of claim 4, wherein
the fuel electrode includes 30 parts by weight to 70 parts by weight of the hollow particles based on 100 parts by weight of the solid oxide electrolyte material.

8. The solid oxide cell of claim 4, wherein
the fuel electrode further includes a fuel electrode material including nickel (Ni), nickel oxide, cobalt (Co), cobalt oxide, ruthenium (Ru), ruthenium oxide, palladium (Pd), palladium oxide, platinum (Pt), platinum oxide, or a combination thereof.

9. The solid oxide cell of claim 8, wherein
the fuel electrode material is in a form of particles having an average particle diameter of 0.1 μm to 5 μm.

10. The solid oxide cell of claim 8, wherein
the fuel electrode includes 30 parts by weight to 70 parts by weight of the fuel electrode material based on 100 parts by weight of the solid oxide electrolyte material.

11. The solid oxide cell of claim 1, wherein
the solid oxide electrolyte includes an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

12. The solid oxide cell of claim 1, wherein
the air electrode includes a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

13. The solid oxide cell of claim 12, wherein
the air electrode further includes a solid oxide electrolyte material.

14. The solid oxide cell of claim 1, wherein
the solid oxide cell is a solid oxide fuel cell (SOFC), a solid oxide electrolyzer cell (SOEC), or both.

15. A method of manufacturing a solid oxide cell, comprising
forming a fuel electrode from a composition including hollow particles including a core having an empty space and a shell including nickel oxide (NiO) particles.

16. The method of claim 15, wherein
the composition further includes a solid oxide electrolyte material.

17. The method of claim 16, wherein
the composition further includes a fuel electrode material.

18. The method of claim 17, wherein
the composition includes
30 parts by weight to 70 parts by weight of hollow particles based on 100 parts by weight of the solid oxide electrolyte material, and
30 parts by weight to 70 parts by weight of the fuel electrode material based on 100 parts by weight of the solid oxide electrolyte material.

19. The method of claim 15, wherein
the forming of the fuel electrode includes casting the composition and then firing the casted composition.

20. A solid oxide cell, comprising
a solid oxide electrolyte,
a fuel electrode on one side of the solid oxide electrolyte, the fuel electrode including:
a fuel electrode material, and
hollow particles that include:
a core having an empty space, and
a shell including nickel oxide (NiO) particles, and
an air electrode on the other side of the solid oxide electrolyte.

21. The solid oxide cell of claim 20, wherein
the fuel electrode further includes a solid oxide electrolyte material.

22. The solid oxide cell of claim 21, wherein
the fuel electrode includes 30 parts by weight to 70 parts by weight of the hollow particles based on 100 parts by weight of the solid oxide electrolyte material.

23. The solid oxide cell of claim 20, wherein
the fuel electrode material includes nickel (Ni), nickel oxide, cobalt (Co), cobalt oxide, ruthenium (Ru), ruthenium oxide, palladium (Pd), palladium oxide, platinum (Pt), platinum oxide, or a combination thereof.

24. The solid oxide cell of claim 21, wherein
the fuel electrode includes 30 parts by weight to 70 parts by weight of the fuel electrode material based on 100 parts by weight of the solid oxide electrolyte material.

25. The solid oxide cell of claim 20, wherein
the shell is free of other metal oxides.
